(19) United States
(12) Patent Application Publication
(10) Pub. No.: US 2007/0201874 A1
(43) Pub. Date: Aug. 30, 2007

(54) Vehicle network system for data transmission using wavelength division scheme and data transmission method in system

(75) Inventor: Hyun-Soo Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/582,758

(22) Filed: Oct. 17, 2006

(30) Foreign Application Priority Data
Feb. 28, 2006 (KR) 2006-19398

(51) Int. Cl. H04J 14/00

(52) U.S. Cl. 398/68

(57) ABSTRACT

A vehicle network system including one master device for receiving multimedia data and at least one slave device, which including the master device for generating optical signals assigned to multimedia services according to wavelengths, confirming the multimedia services to be provided to each of the at least one slave device, and transmitting optical signals of corresponding wavelengths to the at least one slave device; and the at least one slave device for receiving the optical signals, converting the received optical signals into electrical signals, and then reproducing a transport packet.

### PRIORITY

This application claims priority under 35 U.S.C. §119 to an application filed in the Korean Intellectual Property Office on Feb. 28, 2006 and assigned Serial No. 2006-19398, the contents of which are incorporated herein by reference.

### BACKGROUND OF THE INVENTION

1. Field of the Invention

The present invention generally relates to a vehicle network system and a data transmission method in the system, and more particularly to a system for transmitting data by using a wavelength division scheme in a Media Oriented System Transport (MOST) vehicle network system and a data transmission method in the system.

2. Description of the Related Art

With the development of telematics, etc., the electronization trend of a car is on the rise. In accordance with such a trend, various multimedia devices including digital car audios, Digital Versatile Disks (DVDs), etc., have been installed in cars. However, such electronization inevitably causes an increase in wiring in cars. Therefore, car weight increases and gas mileage is reduced. Due to such complexity, car design becomes more difficult. Accordingly, a communication network for simply and quickly processing high capacity information while providing a car with the newest technology is a central theme of next generation car technology development.

In-vehicle network systems are being developed where communication is provided between sensors (parts) and a controller within a car, as in the case of a body and a power train control network.

Recently, with the increase in multimedia applications such as navigation, DVD players and TVs, new requirements have occurred in a network within a vehicle, which results in the emergence of various vehicle network systems. Vehicle network systems normally provide the following four communication methods. A first is a communication method for power train and body control of a vehicle, and refers to a Controller Area Network (CAN) communication method for connecting multiple Electronic Control Units (ECUs) in parallel to transmit/receive data, and providing speed of 1 Mbps at maximum. A second is a communication method for a MOST network, which is an optical-based network for providing a multimedia application service. Such a MOST network currently supports a data rate up to about 25 Mbps, but will support a data rate up to 150 Mbps in the future. A third is a Local Interconnect Network (LIN) communication method applied in order to accomplish applications including door control, seat control, etc. A fourth is a flexray communication method used for accomplishing high reliability applications including airbag operation control. Such a flexray network provides a data rate of about 10 Mbps.

In vehicle network systems, a MOST protocol-based Moving Picture Experts Group (MPEG) DVD player installed in a vehicle may correspond to the MOST network. Multimedia devices such as DVD players transmit/receive data by means of a high speed optical communication network technology standard. Such a vehicle I)VD player generates specific image and voice data from a DVD, and transmits the image and voice data to a vehicle monitor integrated with a speaker together with various control data, thereby allowing the specific image and voice to be reproduced.

Such a MOST network typically has an optical ring topology structure as illustrated in FIG. 1. An 850 nm Vertical Cavity Surface-Emitting Laser (VCSEL) or a 650 nm Light Emitting Diode (LED) is used as the transmitter (Tx) of an optical transceiver in each MOST device, and a plastic optical fiber is used as a transmission line.

A general data transmission operation in a MOST network system for applying a multimedia service to a vehicle will be described with reference to FIG. 1. It is assumed that the MOST network system includes a master device 100 and first to fourth slave devices 102, 104, 106 and 108.

The master device 100 transmits all data, to be transmitted to the first to fourth slave devices 102, 104, 106 and 108, to element 1 of slave device 102. Element 1 of slave device 102 extracts only data required by element 1 from the received data, and transmits the remaining data to element 2 of slave device 104. Likewise, element 2 of slave device 104 extracts only data required by element 2 and transmits the remaining data to element 3 of slave device 106, and element 3 of slave device 106 also extracts only data required by element 3 and transmits the remaining data to element 4 of slave device 108. When data exists which must be transmitted from each slave device to master device 100, each slave device transmits data to master device 100 through other slave devices connected to each slave device. As described above, if master device 100 outputs data, the data are transmitted to the slave devices such as multiple vehicle MOST monitors through one network optical cable installed in a vehicle.

As described above, the MOST network system for applying the multimedia service to the vehicle has a unidirectional ring structure. In the case of transmitting data in such a unidirectional ring structure, if only one of the paths among MOST devices is severed, communication with other devices is impossible, and thus various multimedia services being provided are stopped. In a MOST network system having the structure shown in FIG. 1, even when only element 4 of slave device 108 is to receive a specific multimedia service, master device 100 transfers data to element 4 of slave device 108 through the other slave devices 102, 104 and 106. That is, in order to transfer specific media data to a corresponding device intended for reception of the specific media data, the data are transferred through other devices. Therefore, the abilities of the devices performing only a simple transfer function may deteriorate, and thus transmission quality and efficiency may deteriorate.

### SUMMARY OF THE INVENTION

Accordingly, the present invention has been made to solve the above-mentioned problems occurring in the prior art, and it is an object of the present invention to provide a system for stably transmitting data in a MOST vehicle network system and a data transmission method in the system.

It is another object of the present invention to provide a system for transmitting multimedia data by using a wavelength division scheme in a MOST vehicle network system and a data transmission method in the system.

In accordance with one aspect of the present invention, there is provided a vehicle network system including one master device for receiving multimedia data and at least one slave device, the vehicle network system including the master device for generating optical signals assigned to multimedia services according to wavelengths, confirming the multimedia services to be provided to each of the at least one slave device, and transmitting optical signals of corresponding wavelengths to the at least one slave devices; and the slave devices for receiving the optical signals, converting the received optical signals into electrical signals, and then reproducing a transport packet.

In the present invention, the master device includes a packet generator for generating a transport packet from the received multimedia data by using a time division scheme; a multi-λ optical source transceiver for converting electrical signals of the transport packet into multi-λ optical signals; a data-multiplexer for dividing the multi-k optical signals according to wavelengths, and outputting the optical signals according to the wavelengths; a transmission wavelength selector for selecting an optical signal of a specific wavelength, which is to be provided to each of said at least one slave device, based on control signals, and transmitting the selected optical signal to a corresponding slave device; and a controller for transmitting the control signals to the transmission wavelength selector in order to select optical signals of the wavelengths assigned to the multimedia services to be provided to each of the at least one slave device, and controlling the selected optical signal to be transmitted to the corresponding slave device.

In accordance with another aspect of the present invention, there is provided a data transmission method using a wavelength division scheme in a vehicle network system including one master device for receiving multimedia data and at least one slave device, the data transmission method including generating, by the master device, optical signals assigned to multimedia services according to wavelengths, confirming the multimedia services to be provided to each of the at least one slave device, and transmitting optical signals of corresponding wavelengths to the at least one slave device; and receiving, by the at least one slave device, the optical signals, converting the received optical signals into electrical signals, and then reproducing a transport packet.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a general vehicle network system;

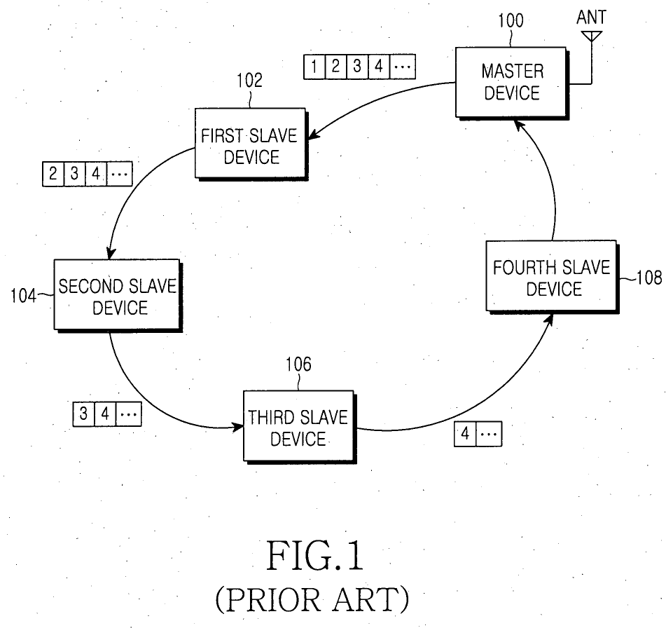

FIG. 2 is a block diagram illustrating the construction of a vehicle network system in which a master device transmits data to slave devices by using a wavelength division scheme according to the present invention; and

FIG. 3 is a flow diagram illustrating a process in which a master device transmits data to slave devices by using a wavelength division scheme in a MOST vehicle network system according to the present invention.

### DETAILED DESCRIPTION OF THE PREFERRED EMBODIMENT

A preferred embodiment of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention provides a solution in which a master device divides a multi-λ optical signal according to multimedia services and transmits the divided optical signals to corresponding slave devices, respectively, in a MOST vehicle network system.

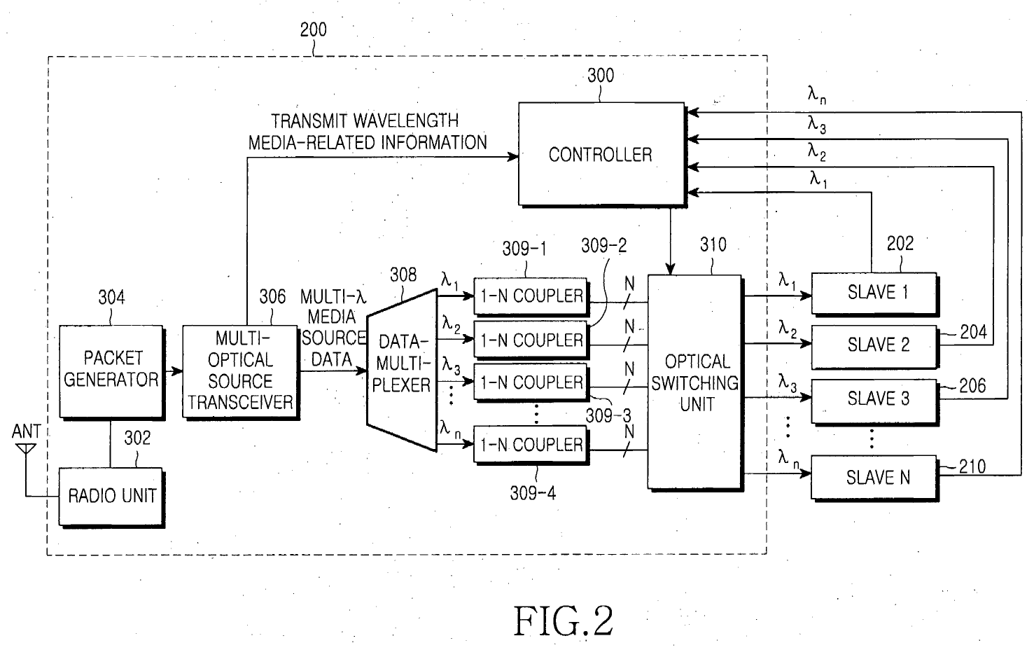

Hereinafter, the construction of a master device and slave devices in a MOST vehicle network system for transmitting multimedia data by using a wavelength division scheme will be described with reference to FIG. 2.

In the present invention, a master device 200 includes a radio unit 302, a packet generator 304, a multi-λ optical source transceiver 306, a data-multiplexer (DMUX) 308, N (N is natural number) number of 1-N couplers 309-1 to 309-4, an optical switching unit 310 and a controller 300. The N number of 1-N couplers 309-1 to 309-4 and the optical switching unit 310 will be referred to as a transmission wavelength selector for selecting specific wavelength optical signals to be transmitted to each slave device.

Further, the master device 200 includes a transmitter (TX) (not shown) for transmitting optical signals according to wavelengths and a receiver (RX) (not shown).

Multimedia data signals for providing a multimedia service are received through the radio unit 302 via an antenna according to the selection of the master device 200 or the slave devices, and are transferred to the packet generator 304. The packet generator 304 generates a transport packet from the received signals by using a time division scheme, and outputs the transport packet to the multi-λ optical source transceiver 306. Only a multimedia service received in a wireless manner is described here, however, the present invention can also be applied to a multimedia service provided in a wired manner.

The multi-λ optical source transceiver 306 converts electrical signals including the input transport packet into multi-λ optical signals, and outputs the optical signals to the data-multiplexer 308. Herein, the multi-λ optical source transceiver 306 provides the controller 300 with multimedia service information assigned according to wavelengths.

Then, the data-multiplexer 308 divides the input multi-λ optical signals according to wavelengths, and outputs the optical signals according to wavelengths to the 1-N couplers 309-1 to 309-4. The 1-N couplers 309-1 to 309-4 divide the received optical signals into N optical signals, and output the N optical signals to the optical switching unit 310. After receiving the optical signals from the 1-N couplers 309-1 to 309-4, the optical switching unit 310 switches optical signals of corresponding wavelengths according to multimedia service selection information received from each slave device under the control of the controller 300, and transmits the switched optical signals to a corresponding slave device through the TX.

If the multimedia service selection information is received from each slave device through the RX, the controller 300 of the present invention controls the optical switching unit 310 by means of the wavelength media-related information transmitted from the multi-λ optical source transceiver 306 in order to provide the multimedia service selected by the slave device.

Hereinafter, an operation by which the controller 300 controls the optical switching unit 310 will be described. First, it is assumed that the multi-λ optical source transceiver 306 has assigned a Digital Multimedia Broadcasting (DMB) service, a Wireless Broadband (WiBro) service, and a wire multimedia service to wavelengths λ₁, λ₂ and λ₃, respectively.

For example, it is assumed that the controller 300 has received first selection information, which is used for receiving the DMB service through element 1 of slave device 202, second selection information, which is used for receiving the Wibro service through element 2 of slave device 204, and third selection information used for receiving the wire multimedia service through element 3 of slave device 206. That is, the controller 300 has received the first and third selection information in order to receive the different multimedia services through each of the slave devices, the controller 300 confirms the wavelength media-related information transmitted from the multi-λ optical source transceiver 306. Herein, the controller 300 confirms the wavelengths assigned to the multimedia services, which are provided to each of the slave devices, from the wavelength media-related information. That is, the controller 300 confirms that the DMB service has been assigned to wavelength λ₁, the Wibro service has been assigned to wavelength λ₂, and the wire multimedia service to has been assigned to wavelength λ₃, from the wavelength media-related information. Then, the controller 300 transmits optical signals of wavelength λ₁, output from the 1-N coupler 309-1, to element 1 of slave device 202 through the optical switching unit 310. The controller 300 transmits optical signals of wavelength λ₂, output from the 1-N coupler 309-2, to element 2 of slave device 204 through the optical switching unit 310. The controller 300 transmits optical signals of wavelength λ₃, output from the 1-N coupler 309-3, to element 2 of slave device 206 through the optical switching unit 310.

In another example, if the controller 300 has received first selection information, which is used for receiving the DMB service through element 1 of slave device 202 and element 2 of slave device 204, and second selection information used for receiving the wire multimedia service through element 3 of slave device 206, the controller 300 confirms wavelength media-related information transmitted from the multi-λ optical source transceiver 306. Herein, the controller 300 confirms wavelengths assigned to the multimedia services, which are provided to each of the slave devices, from the wavelength media-related information. That is, the controller 300 confirms that a DMB service has been assigned to wavelength λ₁, a Wibro service has been assigned to wavelength λ₂, and a wire multimiedia service to has been assigned to wavelength λ₃, from the wavelength media-related information. Then, the controller 300 transmits two optical signals of wavelength λ₁, divided and output through the 1-N coupler 309-1, to element 1 of slave device 202 and element 2 of slave device 204 through the optical switching unit 310. Further, the controller 300 divides an optical signal of wavelength λ₃, output through the data-muliplexer 308, into one optical signal of wavelength λ₃ through the 1-N coupler 309-3, and transmits the one optical signal of wavelength λ₃ to element 2 of slave device 206 through the optical switching unit 310.

Hereinafter, slave devices 202, 204, 206, 208 and 210 will be described. Optical signals received in the slave devices have specific wavelengths, respectively, and multimedia signals have a form of transport packets arranged in a time division scheme. After receiving the optical signals as described above, each of the slave devices 202, 204, 206, 208 and 210 converts the optical signals into electrical signals, thereby reproducing a transport packet. The decoders (not shown) for packet reproduction within the slave devices 202, 204, 206, 208 and 210 separate only necessary multimedia signals from received transport packets, and reproduce the separated multimedia signals. Further, the slave devices 202, 204, 206, 208 and 210 may transmit required multimedia service information to the master device 200 or may report response information for received optical signals to the master device 200. To this end, each of the slave devices 202, 204, 206, 208 and 210 transmits an optical signal of a preset wavelength to the master device 200.

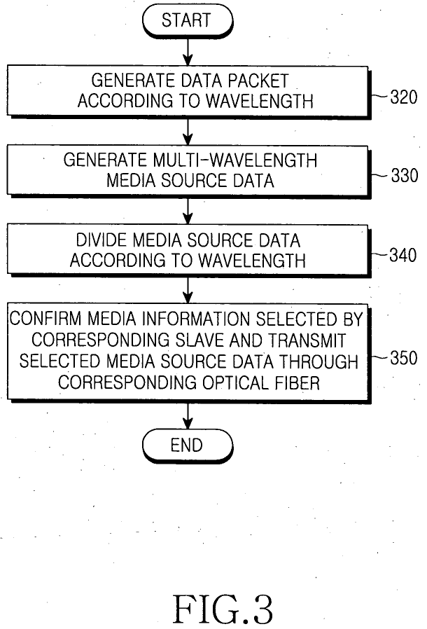

Hereinafter, a process in which the master device transmits data to the slave devices by using a wavelength division scheme in the MOST vehicle network system having the construction as illustrated in FIG. 2 will be described with reference to FIG. 3.

In step 320, if multimedia data signals for providing a multimedia service are received through the radio unit 302 via an antenna according to the selection of the master device 200 or the slave devices, the packet generator 304 generates a transport packet from the received signals by using the time division scheme, and outputs the transport packet to the multi-λ optical source transceiver 306. In step 330, the multi-λ optical source transceiver 306 converts electrical signals including the input transport packet into multi-λ optical signals, and outputs the optical signals to the data-multiplexer 308. Herein, the multi-λ optical source transceiver 306 provides the controller 300 with multimedia service information assigned according to wavelengths.

In step 340, the data-multiplexer 308 divides the input multi-λ optical signals according to wavelengths, and outputs the optical signals according to wavelengths to the 1-N couplers 309-1 to 309-4.

In step 350, the 1-N couplers 309-1 to 309-4 receive the optical signals, divide the received optical signals into N optical signals, and output the N optical signals to the optical switching unit 310. After receiving the optical signals from the 1-N couplers 309-1 to 309-4, the optical switching unit 310 switches optical signals of corresponding wavelengths according to multimedia service selection information received from each slave device under the control of the controller 300, and transmits the switched optical signals to a corresponding slave device through the TX.

According to the present invention as described above, a master device transmits an optical signal for providing multimedia services assigned according to wavelengths to each slave device, differently from an existing ring structure which is the structure of a MOST network for applying multimedia services to a vehicle. In this way, since the master device communicates with each slave device, when a problem occurs in an optical fiber path connected to one or more specific slave devices, only a specific multimedia service being provided to a corresponding slave device may have deteriorated service quality or may be stopped. That is, other services being provided to other slave devices are not affected by the problem.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A vehicle network system including one master device for receiving multimedia data and at least one slave device, the vehicle network system comprising:
the master device for generating optical signals assigned to multimedia services according to wavelengths, confirming the multimedia services to be provided to each of said at least one slave device, and transmitting optical signals of corresponding wavelengths to said at least one slave device, respectively; and
the at least one slave device for receiving the optical signals, converting the received optical signals into electrical signals, and then reproducing a transport packet.

2. The vehicle network system as claimed in claim 1, wherein the master device comprises:
a packet generator for generating a transport packet from the received multimedia data by using a time division scheme;
a multi-λ optical source transceiver for converting electrical signals of the transport packet into multi-λ optical signals;
a data-multiplexer for dividing the multi-λ optical signals according to wavelengths, and outputting the optical signals according to the wavelengths;
a transmission wavelength selector for selecting an optical signal of a specific wavelength, which is to be provided to each of said at least one slave device, based on control signals, and transmitting the selected optical signal to a corresponding slave device; and
a controller for transmitting the control signals to the transmission wavelength selector in order to select optical signals of the wavelengths assigned to the multimedia services to be provided to each of said at least one slave device, and controlling the selected optical signal to be transmitted to the corresponding slave device.

3. The vehicle network system as claimed in claim 2, wherein each of said at least one slave device transmits required multimedia service selection information to the master device through a preset specific wavelength.

4. The vehicle network system as claimed in claim 3, wherein the multi-λ optical source transceiver transmits multimedia service information assigned according to wavelengths to the controller, and the controller compares the multimedia service selection information received from each of said at least one slave device with the multimedia service information assigned according to the wavelengths, confirms the wavelengths assigned to the multimedia services to be provided to each of said at least one slave device, and controls selection of optical signals of the wavelengths assigned to the multimedia services to be provided to each of said at least one slave device.

5. A data transmission method using a wavelength division scheme in a vehicle network system including one master device for receiving multimedia data and at least one slave device, the data transmission method comprising the steps of:
generating, by the master device, optical signals assigned to multimedia services according to wavelengths;
confirming the multimedia services to be provided to each of said at least one slave device;
transmitting, by the master device, optical signals of corresponding wavelengths to said at least one slave device, respectively;
receiving, by the at least one slave device, the optical signals;
converting the received optical signals into electrical signals; and
reproducing a transport packet.

6. The data transmission method as claimed in claim 5, wherein the transmitting step further comprises:
generating a transport packet from the received multimedia data by using the time division scheme;
converting electrical signals of the transport packet into multi-λ optical signals;
dividing the multi-λ optical signals according to wavelengths, and outputting the optical signals according to the wavelengths;
selecting an optical signal of a specific wavelength to be provided to each of said at least one slave device; and
transmitting the selected optical signal to a corresponding slave device.

7. The data transmission method as claimed in claim 6, further comprising transmitting by each of said at least one slave device multimedia service selection information to the master device through a preset specific wavelength.

8. The data transmission method as claimed in claim 7, wherein, in the step of selecting the optical signal, the master device compares the multimedia service selection information received from each of said at least one slave device with multimedia service information assigned according to wavelengths, confirms the wavelengths assigned to the multimedia services to be provided to each of said at least one slave device, and selects optical signals of the wavelengths assigned to the multimedia services to be provided to each of said at least one slave device.
